(19) United States
(12) Patent Application Publication
(10) Pub. No.: US 2003/0161468 A1
(43) Pub. Date: Aug. 28, 2003

(54) Storage device and system

(75) Inventors: Taruhi Iwagaki, Yokohama (JP); Yukio Fujii, Yokohama (JP); Atsuo Kawaguchi, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/087,021

(22) Filed: Feb. 28, 2002

(30) Foreign Application Priority Data
Feb. 25, 2002 (JP) 2002-47863

(51) Int. Cl. H04L 9/00

(52) U.S. Cl. 380/201; 713/176

(57) ABSTRACT

The present invention relates to a storage device provided with a file system for managing operations to record and reproduce data in file units in concentrated accesses made by a plurality of client apparatuses to the storage device through a network. A digital watermark can be embedded into file data handled by the storage device. Parameters required for embedding a digital watermark and digital-watermark-embedding algorithms are managed concentratedly by the storage device.

The storage device has a local file system, a digital-watermark-embedding processing unit and a data recording device for storing data and file-management information. The file-management information includes a digital-watermark-embedding parameter provided for each file and a digital-watermark-embedding parameter common to all files. When the user makes a request for an operation to store file data into the storage device, the local file system drives the digital-watermark-embedding processing unit to embed a digital watermark into the file data on the basis of these parameters and store the file data including the embedded digital watermark in the data recording device.

### BACKGROUND OF THE INVENTION

The present invention relates to a storage device provided with a file system and used particularly for storing audio data and video data.

In recent years, a storage device is shared by a plurality of clients (users) through a general-purpose network such as a LAN. An example of a storage device that can be shared by a plurality of clients (users) through such a network is a storage device having functions of a file server. A storage device having functions of a file server typically includes: a connection means such as a network adaptor for connection to a network; a network protocol for controlling data transfers through the network; a local file system for controlling and managing a recording medium employed in the storage device; and a network-file-sharing protocol for controlling the local file system in response to a data-access request made by a client through the network.

Examples of the network protocol are an ordinary RPC (Remote Procedure Call) and an IP (Internet Protocol). An example of the network-file-sharing protocol is a protocol described in an RFC1813 or RFC959 document of an IETF (Internet Engineering Task Force).

The network-file-sharing protocol receives a request for a data access from a client connected to the network through a network protocol such as the ordinary RPC or the IP, and then reads or writes data from or into the storage medium employed in the storage device by using a local file system owned in the storage device in order to process the request for a data access.

The network-file-sharing protocol controls accesses to data at a file-unit level in a way different from access control at a block level, where a block is the smallest recording unit of the storage device. For this reason, the local file system of the storage device has file-management information for managing a plurality of files. The local file system manages recording-position information indicating what physical location each file is stored at in the recording medium of the storage device. The local file system also carries out processing to map an access at a file level onto an access at a block level of a data-recording device employed in the storage device.

A known typical storage device that can be shared by a plurality of clients through the aforementioned general-purpose network such as a LAN is described in a document with a title of NAS (Network Attached Storage), Nikkei Open Systems, October 2001 Edition, pages 134 to 141.

### SUMMARY OF THE INVENTION

An example of data stored in a storage device that can be shared by a plurality of clients through a network is audio and video content data, which is referred to hereafter as AV data. Audio and video contents are each converted into digital data to be distributed by using a recording medium or through a network. Having properties of digital data, AV data can be copied without causing data deterioration. Thus, the copyright of the AV data may be infringed by, for example, distribution of copied data. In order to solve this problem, there have been proposed technologies for restricting copy operations and for authentication. One of them is a technology for embedding an digital watermark. The digital watermarking technology is a technology for making a change, which is not well recognized by the human senses of sight and hearing, to a portion or all of AV data in order to embed copy control information, information on a copy right or the like in the AV data. Since a digital watermark embedded in AV data can be detected by a detection means, it is possible to limit the number of times an operation to copy the AV data is carried out, to trace a route leading to a distributor distributing the AV data and to do other things. Thus, the digital watermarking technology exhibits an effect of preventing a copyright from being infringed. Japanese Patent Laid-open No. 2000-175019 discloses a technique as such a known typical technology for embedding a digital watermark into AV data. In accordance with this technique, processing is carried out to embed a digital watermark into particularly a moving picture. The processing comprises a process for detecting a moving picture's area with many motions and a process for embedding a digital watermark strongly into such an area.

According to a technique of the processing carried out to embed a digital watermark into AV data, a plurality of pieces of watermark information is embedded into the AV data by carrying out the processing to embed a digital watermark into the AV data the same plurality of times. In this case, the pieces of watermark information are unavoidably superposed on each other, making it difficult to detect all the pieces of watermark information in some cases. In order to solve such a problem, there has been disclosed a method for embedding a plurality of pieces of watermark information in Japanese Patent Laid-open No. 2000-244726. In accordance with this method, a priority level is assigned to each piece of digital watermark information to be embedded into AV data, AV data is divided into areas and pieces of digital watermark information are embedded into the areas in such a way that, the higher the priority level assigned to a piece of digital watermark information, the larger the size of the area into which the piece of digital watermark information is to be embedded. In order to control division of AV data into embedding areas, it is necessary to execute integrated management, that is, it is necessary to adopt a method for assigning a priority level to each piece of digital watermark information and dividing AV data into embedding areas.

Also when writing AV data into a storage device that can be shared by a plurality of clients through a network, an operation to record AV data completing no processing to embed digital watermark therein is not desirable as seen from the viewpoint of protection of a AV-data copyright. In order to solve this problem, there has been conceived a method of storing AV data into such a storage device after carrying out processing to embed a digital watermark into the AV data. In addition, since the AV data is data having a very large size in many cases, an operation to store uncompressed AV data into a storage device is not an operation to effectively utilize the storage capacity of the storage device. In order to more effectively utilize the capacity of the storage device, there has been conceived a method whereby the AV data is subjected to a compression and decompression process in order to reduce the size of the data before the data is stored in the storage device. Examples of the compression and decompression process are MPEG-1 (ISO/IEC11172-2), MPEG-2 (ITU-TH.262, ISO/IEC13818-2) and MPEG-4 (ISO/IEC14496-2). In addition, Japanese Patent Laid-open No. 2000-210007 discloses a storage device, which is used for storing AV data after the AV data is subjected to a process to embed a digital watermark into the AV data and a process to compress data.

It should be noted that a typical application of a storage device shared by a plurality of clients through a network is a system in which an image generated by a plurality of monitoring cameras or a single independent camera is stored in the storage device through a network in a way similar to a network monitoring system. In this case, when it is desired to store an image in the storage device with assurance of the image contents, there is needed a conceived method whereby information on the number of a monitoring camera, a date and a time and the like is embedded in the image as a digital watermark.

As is explained in the description of the conventional technologies, AV data may need to be stored in a storage device shared by a plurality of clients through a network after the AV data is subjected to a process to embed a digital watermark into the AV data and a process to compress data in some cases. In such a case, the AV data may be conceivably written into the storage device after the AV data is subjected to a process to embed a digital watermark into the AV data and a process to compress data. Thus, each individual client must have a digital-watermark-embedding processing means and a compression processing means. As a result, there is raised a problem of a high cost. If the digital-watermark-embedding processing means and the compression processing means are implemented by hardware, the cost increases in particular.

In most of processes to embed a watermark into data, management information such as a management number of a content is embedded in order to protect a copyright. In order to embed such information, it is necessary to execute management of contents intensively. When it is desired to carry out a process to embed a digital watermark into data and a process to compress data by using common parameters and common algorithms, in particular, it is necessary to execute sharing control and management of the parameters and the algorithms. If a plurality of clients is geographically spread, however, it is necessary to newly set a system for the management. For such a system, a dedicated line and a dedicated network-file-sharing protocol may need to be set. In this case, it is necessary to make a change to a terminal used by the client. If a change is made to a terminal used by the client, however, the existing network base can no longer be used. As a result, the cost increases.

It is thus an object of the present invention to provide a storage device that: can be shared by a plurality of users through a network; has a digital-watermark-embedding processing means and a compression processing means; allows a process to embed a digital watermark into data and the process to compress data each to be carried out as an additional process in a file write operation according to a command issued by the user; allows parameters required for the process to embed a digital watermark into data and the process to compress data as well as algorithms required for the processes to embed a digital watermark into data and the processes to compress data to be managed and controlled with ease; and maintains compatibility such as a network-file-sharing protocol.

In order to solve the problems described above, the present invention provides a storage device having a file system and the file system's input/output means such as a network-file-sharing protocol. The storage device further has an additional digital-watermark-embedding processing means and an additional data compressing means in the file system. The storage means uses additional control parameters required for a process to embed a digital watermark into data and a process to compress data in file-management information for managing, among other data, information on recording locations of the file system's files in the storage device. The file system is thus an expanded file system in which the digital-watermark-embedding process and the compression process, which use the control parameters, are each carried out as an additional process in an operation to make an access to a file. In addition, the client has an additional means for setting and updating the control parameters. This additional means is employed by keeping compatibility with the input/output means of the file system.

By providing the sharable storage device with a digital-watermark-embedding processing means and a compression processing means, the client is not required to individually have its own digital-watermark-embedding processing means and compression processing means. In addition, by extending the file system by using a file management information area of the conventional file system, it is possible to intensively manage the control parameters required for the process to embed a digital watermark into data and the process to compress data with ease.

### BRIEF DESCRIPTION OF THE DRAWINGS

FIG. 1 is a diagram showing the configuration of a storage device implemented by a first embodiment of the present invention;

FIG. 2 is a diagram showing the configuration of a compression processing unit 1011 provided in a second embodiment of the present invention;

FIG. 3 is a diagram showing the configuration of a decompression processing unit 1012 provided in the second embodiment of the present invention;

FIG. 4 is a diagram showing the configuration of a digital-watermark-embedding processing unit 110 provided by the first embodiment of the present invention;

FIG. 5 is a diagram showing the configuration of file management information 108 used in the first embodiment of the present invention;

FIG. 6 is a diagram showing a format of data for setting management information in the first embodiment of the present invention;

FIG. 7 is a diagram showing another format of data for setting the management information in the first embodiment of the present invention;

FIG. 8 is a diagram showing a flow of processing in the first embodiment of the present invention;

FIG. 9 is a diagram showing a continuation flow of processing in the first embodiment of the present invention;

FIG. 10 is a diagram showing the configuration of a storage device implemented by the second embodiment of the present invention;

FIG. 11 is a diagram showing the configuration of file management information 108 used in the second embodiment of the present invention;

FIG. 12 is a diagram showing a format of data f or setting management information in the second embodiment of the present invention;

FIG. 13 is a diagram showing another format of data for setting the management information in the second embodiment of the present invention;

FIG. 14 is a diagram showing a flow of processing in the second embodiment of the present invention;

FIG. 15 is a diagram showing a continuation flow of processing in the second embodiment of the present invention;

FIG. 16 is a diagram showing another continuation flow of processing in the second embodiment of the present invention;

FIG. 17 is a diagram showing a further continuation flow of processing in the second embodiment of the present invention;

FIG. 18 is a diagram showing the configuration of a monitoring system implemented by a third embodiment of the present invention;

FIG. 19 is a diagram showing the configuration of file management information 108 used in the third embodiment of the present invention;

FIG. 20 is a diagram showing a flow of processing in the third embodiment of the present invention; and

FIG. 21 is a diagram showing a continuation flow of processing in the third embodiment of the present invention.

### PREFERRED EMBODIMENTS OF THE INVENTION

1. First Embodiment

A first embodiment's configuration and flow of processing will be described as follows. The first embodiment has the network-file-sharing protocol explained in the description of the conventional technology. In addition, the first embodiment also has a local file system. The first embodiment applies the present invention to a storage device accessed concentratedly by a plurality of client apparatus through a network. A digital-watermark-processing unit is added to the local file system and a means for controlling the digital-watermark-processing unit is provided so that a client apparatus is allowed to make a request for execution of a process to embed a digital watermark into a file to be recorded in the storage device. A method for embedding a digital watermark into a moving picture as disclosed in aforementioned Japanese Patent Laid-open No. 2000-175019 is adopted as a method for processing a digital watermark.

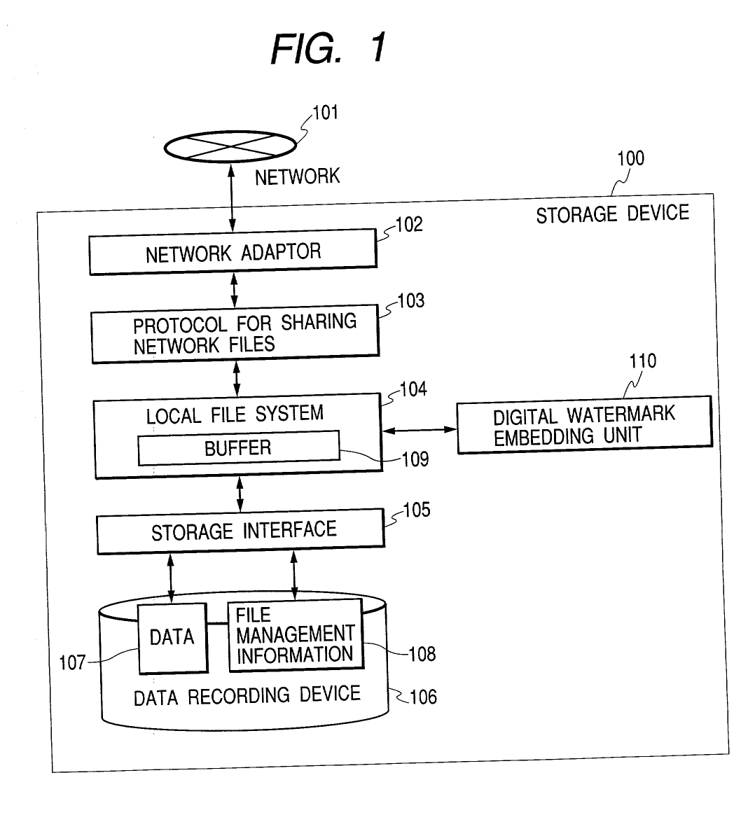

To begin with, a storage device 100 implemented by the first embodiment of the present invention is explained by referring to FIG. 1. A network adaptor 102 is connected to a network 101 and a network-file-sharing protocol 103. A command and data, which are transmitted by the client through the network 101, are received and supplied to the network-file-sharing protocol 103. On the other hand, a processing result output by the network-file-sharing protocol 103 is transmitted to the user by way of the network 101.

The network-file-sharing protocol 103 is connected to the network adaptor 102 and a local file system 104. The network-file-sharing protocol 103 is a process for converting a command and data, which are received from the network adaptor 102, into a converted command and converted data respectively for the local file system 104. The converted command and the converted data are then supplied to the local file system 104 in order to request the local file system 104 to carry out processing. On the other hand, a processing result produced by the local file system 104 is converted into a processing result of the command issued for the network-file-sharing protocol 103, and the processing result obtained as a result of this conversion is then transmitted to a client by way of the network adaptor 102.

The local file system 104 is connected to the network-file-sharing protocol 103 and a digital-watermark-embedding processing unit 110. The local file system 104 is also connected to a data-recording device 106 through a storage interface 105. The data-recording device 106 is an information-recording unit such as a magnetic-disc drive or an optical-disc drive. The local file system 104 also has a buffer 109 for storing processing data on a temporary basis. The local file system 104 is a process for interpreting a command and data, which are requested by the network-file-sharing protocol 103, and for processing the command by controlling transfers of data, the operation of the digital-watermark-embedding processing unit 110 and operations to write or read data into and from the data-recording device 106 through the storage interface 105. The following description is a detailed explanation of the digital-watermark-embedding processing unit 110 and the data-recording device 106, which are controlled by the local file system 104.

The digital-watermark-embedding processing unit 110 typically comprises a motion estimation unit 401 and an embedding unit 402 as shown in FIG. 4 for example. The digital-watermark-embedding processing unit 110 receives video data, information on a digital watermark to be embedded and parameters required for a process to embed the digital watermark. An example of the parameters is an intensity of embedding. The motion estimation unit 401 processes the video data to compute changes in movement in the video data, which is treated like a moving picture. The motion estimation unit 401 supplies a result of the processing to the embedding unit 402. The embedding unit 402 carries out processing to embed a digital watermark into the video data by using the video data, the information on the digital watermark and parameters such as the intensity of embedding, which are received from the local file system 104, as well as the computation result received from the motion estimation unit 401. The video data including the embedded digital watermark is then output to the local file system 104.

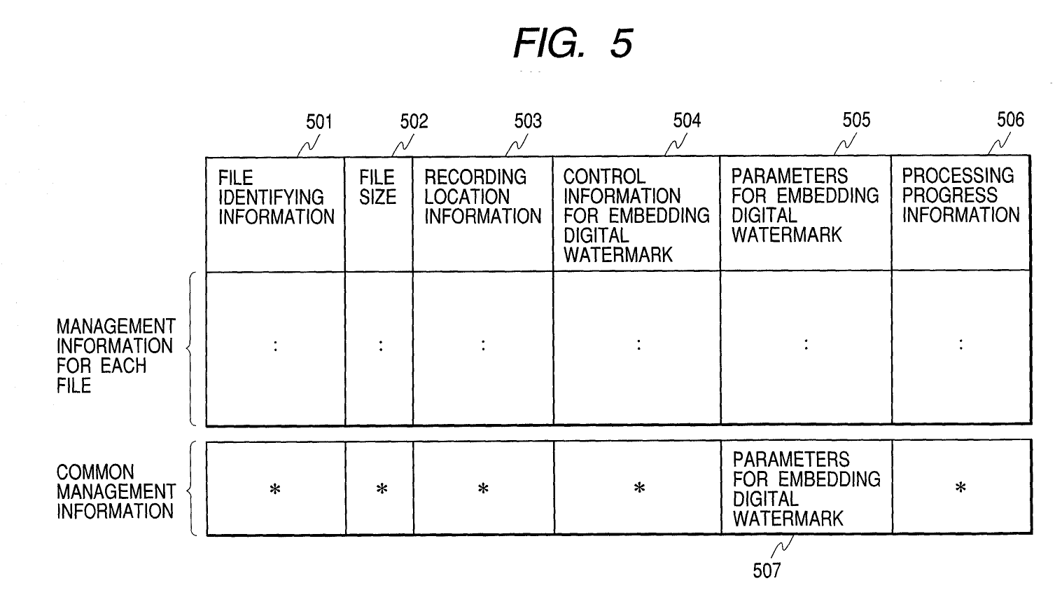

Controlled by the local file system 104 through the storage interface 105, the data-recording device 106 reads as well as writes data 107 and file-management information 108 from and into a recording medium employed in the data-recording device 106. The data 107 is a set of files. The file-management information 108 also referred to as an inode is managed by the local file system 104. The file-management information 108 includes file-identification information also referred to as an inode number, a file size and information on file recording locations in the data-recording device 106. The information on recording location of a file typically includes a volume number or a block number. The file-management information 108 is typically a table like one shown in FIG. 5. In the case of this embodiment, the file-management information 108 newly includes additional areas for storing digital-watermark-embedding control information 504, digital-watermark-embedding parameters 505 and processing-progress information 506. The digital-watermark-embedding control information 504, the digital-watermark-embedding parameters 505 and the processing-progress information 506 are provided for each file. In addition, the file-management information 108 also has an additional area for digital-watermark-embedding parameters 507, which are common to all files. The digital-watermark-embedding control information 504 shows mode A, B or C. Mode A is a mode in which no digital-watermark-embedding processing is to be carried out. Mode B is a mode in which digital-watermark-embedding processing is to be carried out by using the digital-watermark-embedding parameters 505, which are set for each file. Mode C is a mode in which digital-watermark-embedding processing is to be carried out by using the digital-watermark-embedding parameters 507, which are common to all files. If no information is set in the digital-watermark-embedding control information 504, mode A is assumed to be the default mode. The local file system 104 controls processing to embed a digital watermark in an operation to store a file by referring to the digital watermark-embedding control information 504 and the digital-watermark-embedding parameters 505 or the digital-watermark-embedding parameters 507. This control will be explained in detail in the description of a processing flow.

It should be noted that, in the configuration shown in FIG. 1, the network-file-sharing protocol 103, the local file system 104 and a portion or all of the digital-watermark-embedding processing unit 110 are implemented by software in some cases. In addition, even though the file-management information 108 is stored in the data-recording device 106, the file-management information 108 may also be cached (or held on a temporary basis) in a memory or a recording medium employed in the local file system 104.

Furthermore, in some cases, the data-recording device 106 is blocked into typically predetermined capacity units and a file written into the data-recording device 106 is stored therein by being divided into a plurality of blocks. In this case, information indicating which blocks a file has been written in is recorded in the file-management information 108 as recording-location information 503. Thus, when receiving a request to read a file, the local file system 104 acquires the recording-location information 503 for the file from the file-management information 108 to identify which blocks data to be read are stored in. The data is then read from the blocks. The above explanation of the configuration of the first embodiment is finished here.

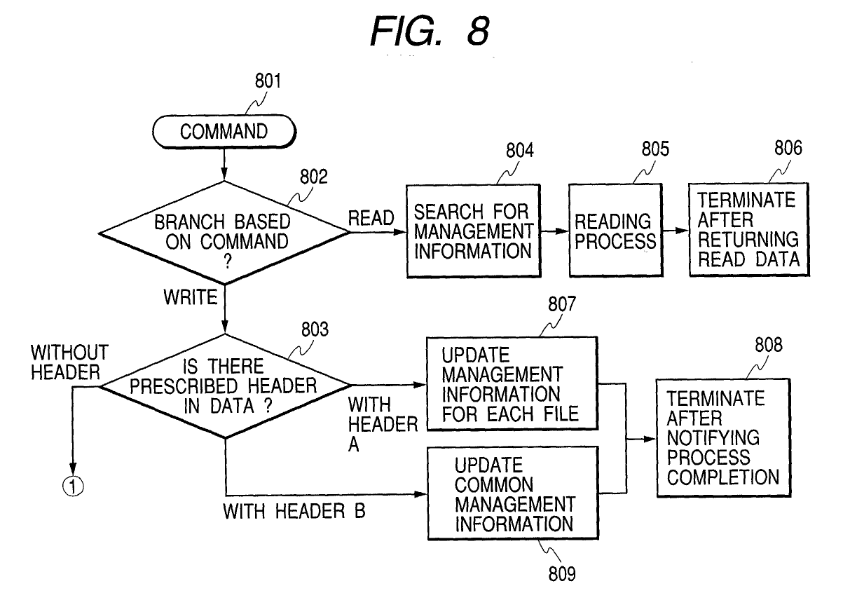

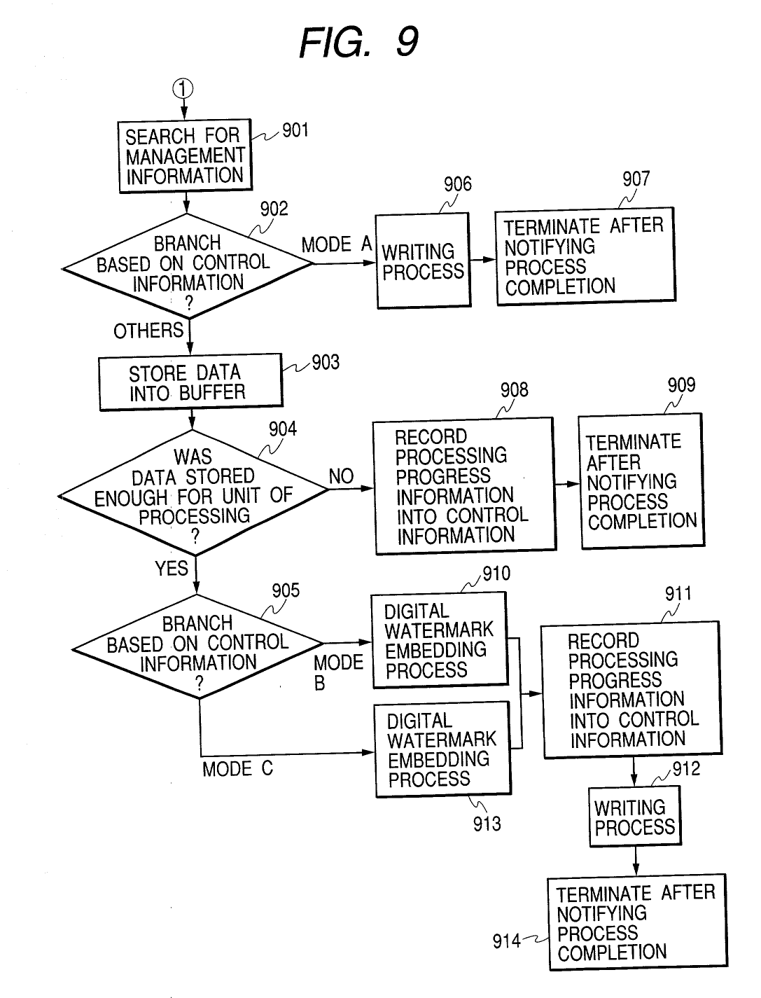

The following description explains details of a flow of processing carried out in the first embodiment as requested by a command issued by a client by referring to FIG. 1 and flowcharts shown in FIGS. 8 and 9. Some commands of the network-file-sharing protocol are defined. However, the following description picks up only file-read and file-write commands, which are needed for explanation of embodiments of the present invention. The network-file-sharing protocol 103 converts a command issued to the network-file-sharing protocol 103 into a command 801 for the local file system 104, supplying the command 801 to the local file system 104 in order to request the local file system 104 to carry out processing. A procedure represented by the flowcharts referred to in the following description is a flow of processing carried out by the local file system 104 in accordance with the command 801.

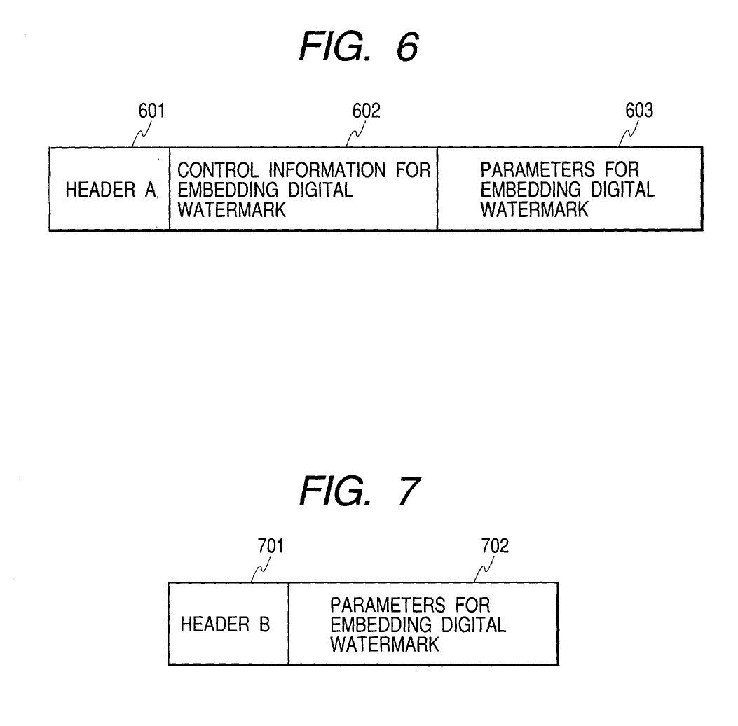

It should be noted that a setting and updating means for respectively setting and updating fields in the file-management information 108 of the file system in the embodiment is set in a way described below. The fields are the digital-watermark-embedding control information 504 and the digital-watermark-embedding parameters 505, which are provided for each file, and the digital-watermark-embedding parameters 507 common to all files. When a client updates the digital-watermark-embedding control information 504 and the digital-watermark-embedding parameters 505, which are provided for each file, the client issues a command to write special data for a file whose fields are to be updated to the local file system 104 by way of the network-file-sharing protocol 103. Referred to hereafter as management-information-setting data, the special data has a configuration shown in FIG. 6. If it is desired to update the digital-watermark-embedding parameters 507 common to all files, on the other hand, the client issues a command to write management-information-setting data having the configuration shown in FIG. 7 for any arbitrary file to the local file system 104 by way of the network-file-sharing protocol 103. The following description explains a flow of processing carried out by the local file system 104 when the local file system 104 is requested to write a file in accordance with the command.

Initially, a received command 801 is checked to determine a branch destination of the processing flow. If the command 801 is a write command, the flow of the processing goes on to a step 803. If the command 801 is a read command, on the other hand, the flow of the processing goes on to a step 804. First of all, processing carried out for the write command is explained. Arguments of a write command include a file handle, that is, file-identification information identifying a file into which data is to be written, data to be recorded into the file and a location at which data is to be recorded in the file. A location at which data is to be recorded in a file is typically a byte address relative to the file's beginning, which is set normally as an address of 0.

In the case of a write command, the flow of the processing goes on to a step 803 to form a judgment as to whether the data given specified by an argument of the write command as data to be stored in the file is management-information-setting data including a header A 601 shown in FIG. 6 or a header B 701 shown in FIG. 7 in order to determine a branch destination of the processing flow. If the data to be written is management-information-setting data including a header A 601 shown in FIG. 6, the flow of the processing goes on to a step 807. If the data to be written is management-information-setting data including a header B 701 shown in FIG. 7, the flow of the processing goes on to a step 809. If the data to be written is not management-information-setting data, the flow of the processing goes on to a step 901 of the flowchart shown in FIG. 9.

If the flow of the processing goes on to the step 807, the local file system 104 makes an access to the file-management information 108 through the storage interface 105 to search the file-management information 108 for fields of the digital-watermark-embedding control information 504 and the digital-watermark-embedding parameters 505, which are associated with a file indicated by the file-identification information given as an argument of the write command and to update the fields with contents of fields of the management-information-setting data's digital-watermark-embedding information 602 and digital-watermark-embedding parameters 603. Finally, at a step 808, the processing is ended by returning a notice of processing completion to the network-file-sharing protocol 103.

If the flow of the processing goes on to the step 809, the local file system 104 makes an access to the file-management information 108 through the storage interface 105 to search the file-management information 108 for the field of the digital-watermark-embedding parameters 507 and to update the field with contents of the field of the management-information-setting data's digital-watermark-embedding parameters 702. In this case, since the local file system 104 updates file management information common to all files instead of file management information provided for a specific file, the file-identification information given as an argument of the write command is ignored. Finally, at the step 808, the processing is ended by returning a notice of processing completion to the network-file-sharing protocol 103.

If the flow of the processing goes on to the step 807 or 809, the local file system 104 carries out processing as described above. Thus, if a client requests the network-file-sharing protocol 103 to write management-information-setting data through the network, the data is automatically reflected by the local file system 104 in the file-management information 108.

The following description explains a flow of processing, which is carried out when the flow of processing branches to the step 901, by referring to the flowchart shown in FIG. 9. At the step 901, the local file system 104 makes an access to the file-management information 108 through the storage interface 105 to search the file-management information 108 for fields of the file size 502, the recording-location information 503, the digital-watermark-embedding control information 504 and the digital-watermark-embedding parameters 505, which are associated with a file indicated by the file-identification information given as an argument of the write command and to obtain the fields from the file-management information 108. In addition, the local file system 104 also obtains the field of the digital-watermark-embedding parameters 507 common to all files from the file-management information 108. The flow of the processing then goes on to a step 902 to determine a branch destination of the processing flow in accordance with the contents of the digital-watermark-embedding control information 504 obtained at the preceding step. If the digital-watermark-embedding control information 504 shows mode A, that is, a mode in which no digital-watermark-embedding processing is to be carried out, the flow of the processing goes on to a step 906. If the digital-watermark-embedding control information 504 shows mode B, that is, a mode in which digital-watermark-embedding processing is to be carried out by using the digital-watermark-embedding parameters 505 or mode C, that is, a mode in which digital-watermark-embedding processing is to be carried out by using the digital-watermark-embedding parameters 507, on the other hand, the flow of the processing goes on to a step 903.

If the flow of the processing goes on to the step 906, the local file system 104 computes a write location in the data recording device 106 and writes data into the data-recording device 106 through the storage interface 105. The write location is a location at which data to be written is to be recorded. The write location is computed by using the write command's argument indicating a location, at which the data is to be written, as well as a file's file size 502 and recording-information location 503, which have been obtained at the step 901. Finally, at a step 907, the processing is ended by returning a notice of processing completion to the network-file-sharing protocol 103.

If the flow of the processing goes on to the step 903, on the other hand, the data specified by an argument of the write command as data to be written is stored in a buffer 109. Then, the flow of the processing goes on to a step 904 at which a branch destination of the processing flow is determined in accordance with whether or not data of a unit of the digital-watermark-embedding processing has been stored in the buffer 109. If data of a unit of the digital-watermark-embedding processing was not stored, the flow of the processing goes on to a step 908. At the step 908, the local file system 104 makes an access to the file-management information 108 through the storage interface 105 and records processing-progress information into the processing-progress information 506 of the file-management information 108. Finally, at a step 909, the processing is ended by returning a notice of processing completion to the network-file-sharing protocol 103. The processing-progress information is the location and the size of data to be written without carrying out processing to embed a digital watermark. The data to be written is left in the buffer 109. If data of a unit of the digital-watermark-embedding processing was stored, on the other hand, the flow of the processing goes on to a step 905 at which a branch destination of the processing flow is determined in accordance with the digital-watermark-embedding control information 504 obtained earlier. If the digital-watermark-embedding control information 504 shows mode B, that is, a mode in which digital-watermark-embedding processing is to be carried out by using the digital-watermark-embedding parameters 505 set for each file, the flow of the processing goes on to a step 910. If the digital-watermark-embedding control information 504 shows mode C, that is, a mode in which digital-watermark-embedding processing is to be carried out by using the digital-watermark-embedding parameters 507 common to all files, on the other hand, the flow of the processing goes on to a step 913.

If the flow of the processing goes on to the step 910, the local file system 104 supplies the digital-watermark-embedding parameters 505 obtained at the step 901 and data of one processing unit stored in the buffer 109 to the digital-watermark-embedding processing unit 110, requesting the digital-watermark-embedding processing unit 110 to carry out processing to embed a digital watermark. If data of a plurality of processing units is stored in the buffer 109, the processing to embed a digital watermark is repeated for each of the processing units. If data is left in the buffer 109 without being subjected to the processing to embed a digital watermark, the location of the data in the buffer 109 and the size of the data are recorded in the processing-progress information 506 of the file-management information 108 at the next step 911. Then, at the subsequent step 912, the local file system 104 computes a write location of data to be written in the data recording device 106 and writes the data into the data-recording device 106 through the storage interface 105. The data is data returned by the digital-watermark-embedding processing unit 110 after the data has completed the processing to embed a digital watermark in the digital-watermark-embedding processing unit 110. The write location is a location at which data to be written is to be recorded. The write location is computed by using the write command's argument indicating a location, at which the data is to be written, as well as a file's file size 502 and recording-information location 503, which have been obtained at the step 901. Finally, at a step 914, the processing is ended by returning a notice of processing completion to the network-file-sharing protocol 103.

If the flow of the processing goes on to the step 913, on the other hand, the local file system 104 supplies the digital-watermark-embedding parameters 507 obtained at the step 901 and data of one processing unit stored in the buffer 109 to the digital-watermark-embedding processing unit 110, requesting the digital-watermark-embedding processing unit 110 to carry out processing to embed a digital watermark. Subsequently, at the next step 911, status of data left in the buffer 109, if any, is recorded in the processing-progress information 506. Then, at the next step 912, the data returned by the digital-watermark-embedding processing unit 110 is recorded in the data-recording device 106 as is the case with the branch from the step 905 to the step 910. The data is returned by the digital-watermark-embedding processing unit 110 after the data has completed the processing to embed a digital watermark in the digital-watermark-embedding processing unit 110. Finally, at the step 914, the processing is ended by returning a notice of processing completion to the network-file-sharing protocol 103.

The processing described above is processing carried out in case the command 801 is a write command. The following description explains processing carried out for a read command. Arguments of a read command are file-identification information identifying a file from which data is to be read, the size of data to be read from the file and the data 's location from which the data is to be read from the file.

If the flow of the processing goes on to the step 804, the local file system 104 makes an access to the file-management information 108 through the storage interface 105 to search the file-management information 108 for fields of the file size 502 and the recording-location information 503, and to obtain the fields from the file-management information 108. The file size 502 and the recording-location information 503 are provided for a file identified by the file-identification information given as an argument of the read command.

Then, a location, from which the data to be fetched is read out from the data recording device, is computed by using the size of the data to be read out, the location in the file from which the data is to be read out, the file size 502 and the recording-location information 503. The size of the data to be read out and the location in the file from which the data is to be read out are each given as an argument of the read command. On the other hand, the file size 502 and the recording-location information 503 have been obtained in the search operation. Then, the data is read out from the data-recording device 106 through the storage interface 105. Finally, at a next step 806, the processing is ended by returning the read data and a notice of processing completion to the network-file-sharing protocol 103.

The processing described above is carried out in the embodiment. Thus, when a client desires to store uncompressed video data in the data recording device after processing to embed a digital watermark into the data, first of all, a request is made through the network-file-sharing protocol 103 to create a file. Then, management-information-setting data with a format shown in FIG. 6 or 7 for a mode set to carry out processing to embed a digital watermark is written through the network-file-sharing protocol 103. The mode to carry out processing to embed a digital watermark can be mode C or B. By doing so, the processing to embed a digital watermark into the file becomes valid so that the contents of the file for storing the video data to be written into the data recording device 106 are recorded into the data recording device 106 after being subjected to the processing to embed a digital watermark. In this embodiment, however, it is assumed that video data is written in a sequential manner so that it is necessary to limit the processing only to clients not desiring random accesses during a write operation. If the operation to write the management-inform-setting data added by the present invention is not carried out, the ordinary file write operation is performed.

2. Second Embodiment

A second embodiment's configuration and flow of processing will be described as follows. The second embodiment is obtained by adding a video-data-compressing means and a video-data-decompressing means to the first embodiment and by providing a means for controlling the video-data-compressing means and the video-data-decompressing means so as to allow a client to have compression processing carried out in addition to the processing to embed a digital watermark into a file to be recorded into the storage device 100. In the case of the second embodiment, a file read from the storage device 100 is output after being decompressed. As a compression and decompression technique, it is possible to adopt the MPEG-4, MPEG-2 or MPEG-1 system explained in the description of the conventional technologies. Only differences from the first embodiment are explained as follows.

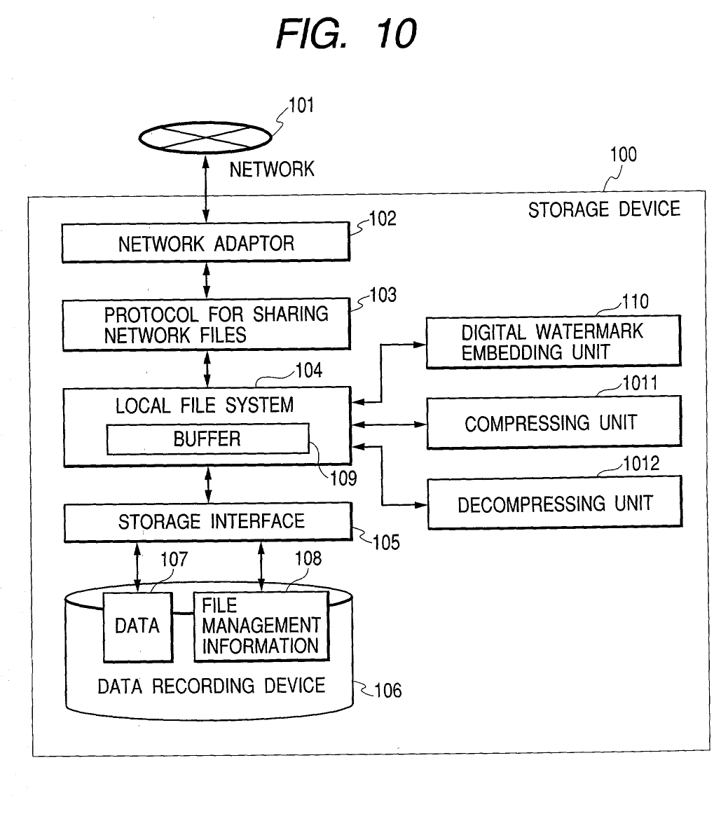

First of all, the configuration of the storage device 100 employed in the second embodiment of the present invention is explained by referring to FIG. 10. The local file system 104 is also connected to a compressing unit 1011 and a decompressing unit 1012 in addition to the network-file-sharing protocol 103, the digital-watermark-embedding processing unit 110 and the data-recording device 106.

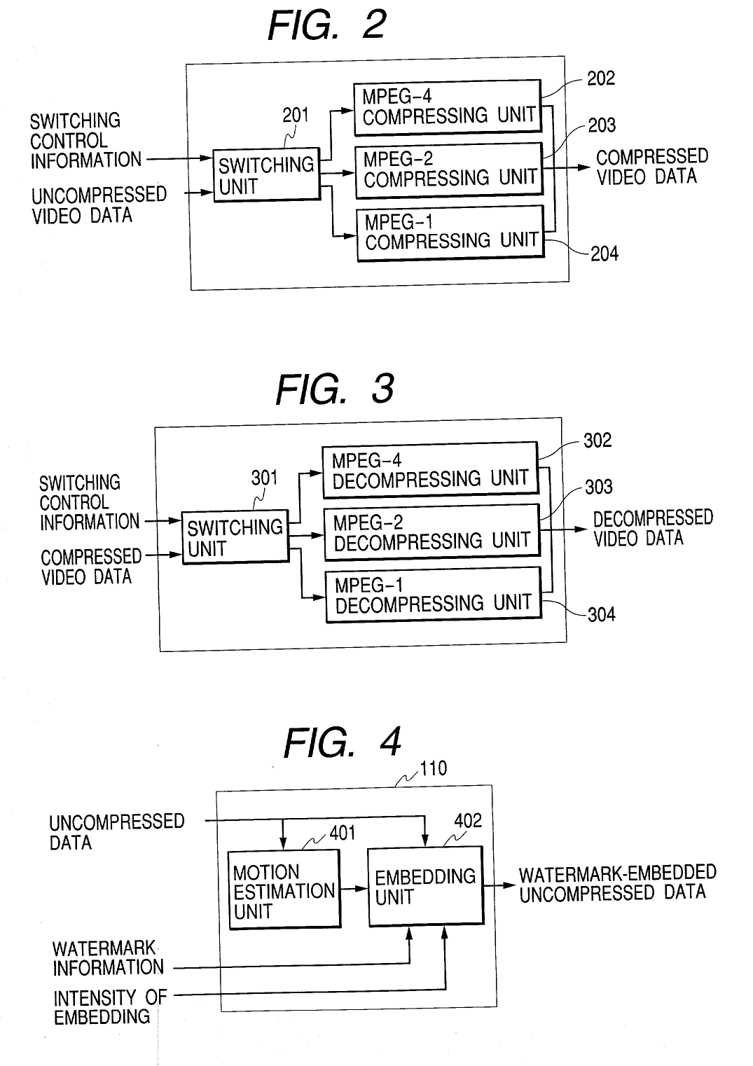

As shown in FIG. 2, the compressing unit 1011 comprises a switching unit 201, an MPEG-4 compressing unit 202, an MPEG-2 compressing unit 203 and an MPEG-1 compressing unit 204 for example. When uncompressed video data and parameters needed in processing to compress data are received from the local file system 104, the uncompressed video data is passed on to the switching unit 201. An example of the parameters needed in processing to compress data is control information for selecting a compression method. The switching unit 201 supplies the uncompressed video data to one of the MPEG-4 compressing unit 202, the MPEG-2 compressing unit 203 and the MPEG-1 compressing unit 204 in dependence on the value of one of the parameters. The uncompressed video data is compressed by the MPEG-4 compressing unit 202, the MPEG-2 compressing unit 203 or the MPEG-1 compressing unit 204 in accordance with the MPEG-4, MPEG-2 or MPEG-1 method respectively. Compressed video data obtained as a result of compression is output to the local file system 104.

As shown in FIG. 3, the decompressing unit 1012 typically comprises a switching unit 301, an MPEG-4 decompressing unit 302, an MPEG-2 decompressing unit 303 and an MPEG-1 decompressing unit 304. When compressed video data and parameters needed in processing to decompress data are received from the local file system 104, the compressed video data is passed on to the switching unit 301. An example of the parameters needed in processing to decompress data is control information for selecting a decompression method. The switching unit 301 supplies the uncompressed video data to one of the MPEG-4 decompressing unit 302, the MPEG-2 decompressing unit 303 and the MPEG-1 decompressing unit 304 in dependence on the value of one of the parameters. The compressed video data is decompressed by the MPEG-4 decompressing unit 302, the MPEG-2 decompressing unit 303 or the MPEG-1 decompressing unit 304 in accordance with the MPEG-4, MPEG-2 or MPEG-1 method respectively. Decompressed video data obtained as a result of decompression is output to the local file system 104.

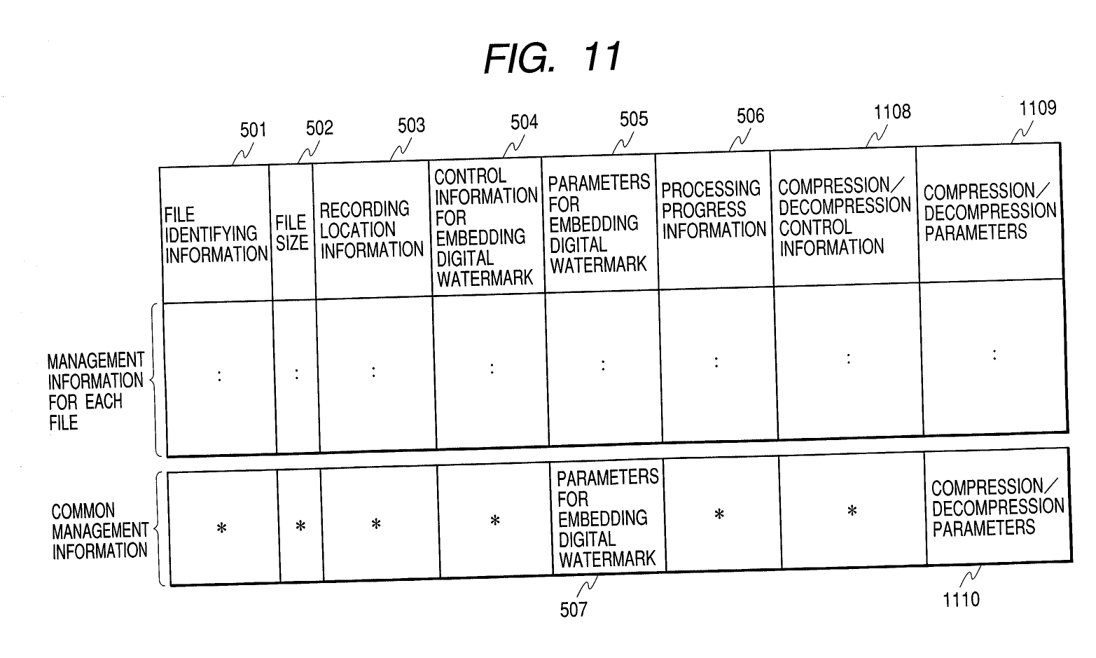

The file-management information 108 managed by the local file system 104 is extended from that used in the first embodiment. The extended file management information is for example a table like one shown in FIG. 11. In addition to the information used in the first embodiment, table used in this embodiment also includes additional areas for recording compression/decompression control information 1108 and compression/decompression parameters 1109 required for compression/decompression processing. The compression/decompression control information 1108 and the compression/decompression parameters 1109 are provided for each, file. Furthermore, the table also includes an additional area for recording compression/decompression parameters 1110 required for compression/decompression processing. The compression/decompression parameters 1110 are parameters common to all files. In the compression/decompression control information 1108, it is possible to set mode D, mode E or mode F. Mode D is a mode in which processing to compress data is not to be carried out prior to an operation to write a file. Mode E is a mode in which processing to compress data is to be carried out by using the compression/decompression parameters 1109 set for a file prior to an operation to write the file. Mode F is a mode in which processing to compress data is to be carried out by using the compression/decompression parameters 1110 common to all files prior to an operation to write a file. If no information is set in the compression/decompression control information 1108, mode D is assumed to be the default mode. The local file system 104 controls processing to compress data in a write operation and processing to decompress data in a read operation by referring to the compression/decompression control information 1108 and the compression/decompression parameters 1109 or the compression/decompression parameters 1110. This control will be described in detail in an explanation of a processing flow.

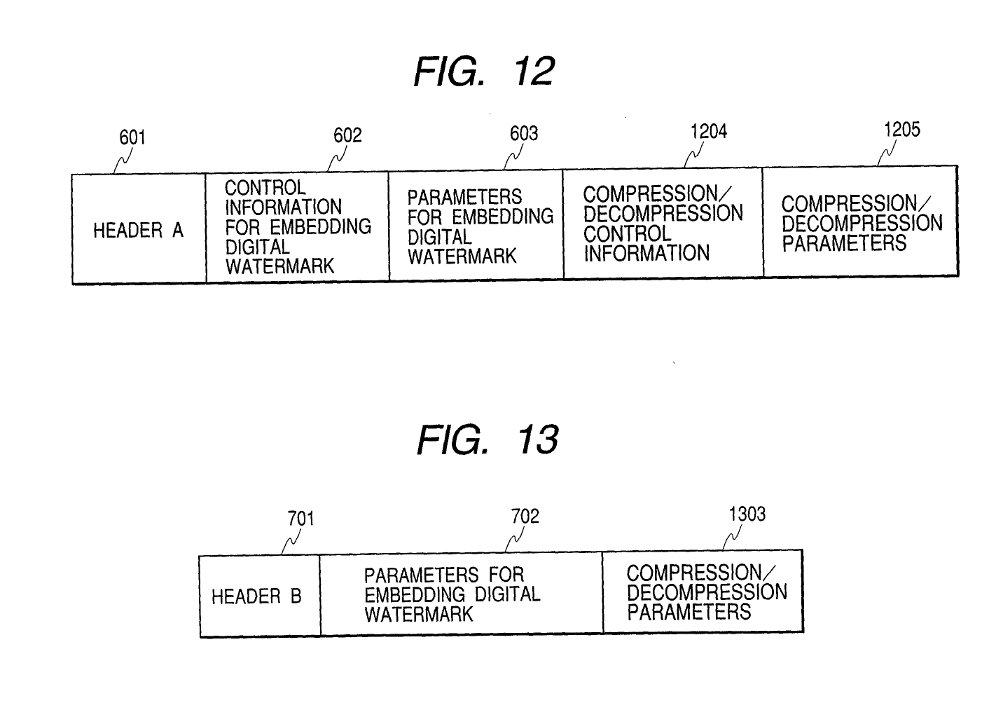

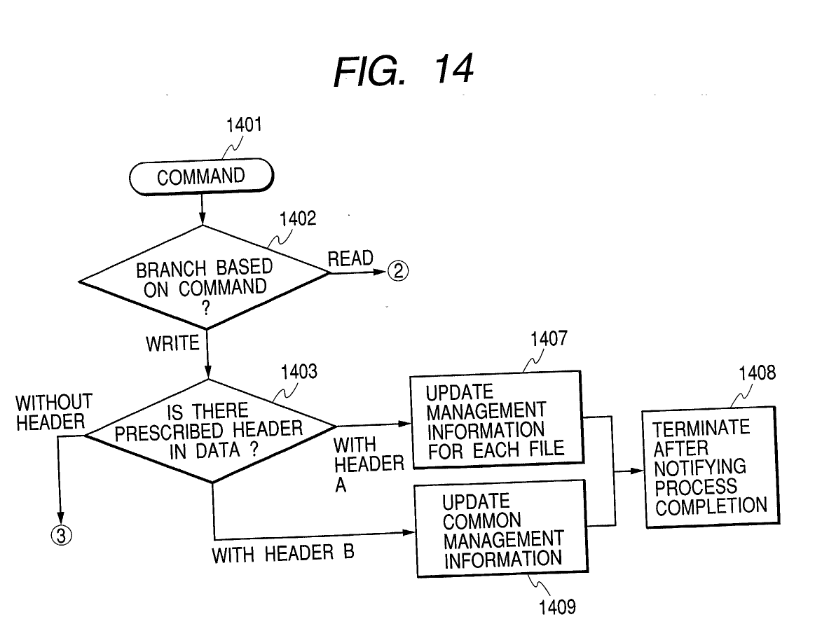

By referring to FIG. 10 and flowcharts shown in FIGS. 14 to 17, the following description explains details of a flow of processing carried out in the second embodiment as requested by a command issued by a client. The second embodiment is different from the first embodiment in that, in the case of the second embodiment, additional processing related to compression is carried out in execution of a write command and additional processing to decompress data is carried in execution of a read command. In addition, in the case of the second embodiment, the configuration of the management-information-setting data is extended as shown in FIG. 12 and FIG. 13. As described earlier, the management-information-setting data is used in an operation to set or update the contents of the file-management information 108 owned by the file system. As shown in the figure, the management-information-setting data includes additional fields of compression/decompression control information 1204 and compression/decompression parameters 1205 for each file; and an additional field of common compression/decompression parameters 1303.

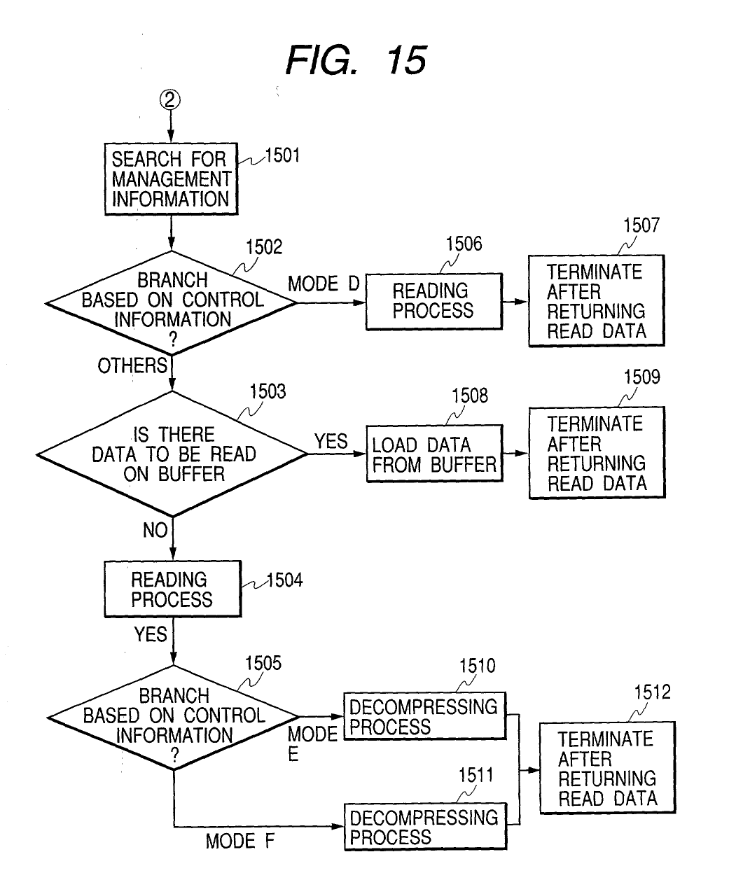

Initially, a branch destination of the processing flow is determined in accordance with the type of a received command 1401. If the command 1401 is a write command, the flow of the processing goes on to a step 1403. If the command 1401 is a read command, on the other hand, the flow of the processing goes on to a step 1501 of the flowchart shown in FIG. 15. First of all, processing carried out for a write command is explained.

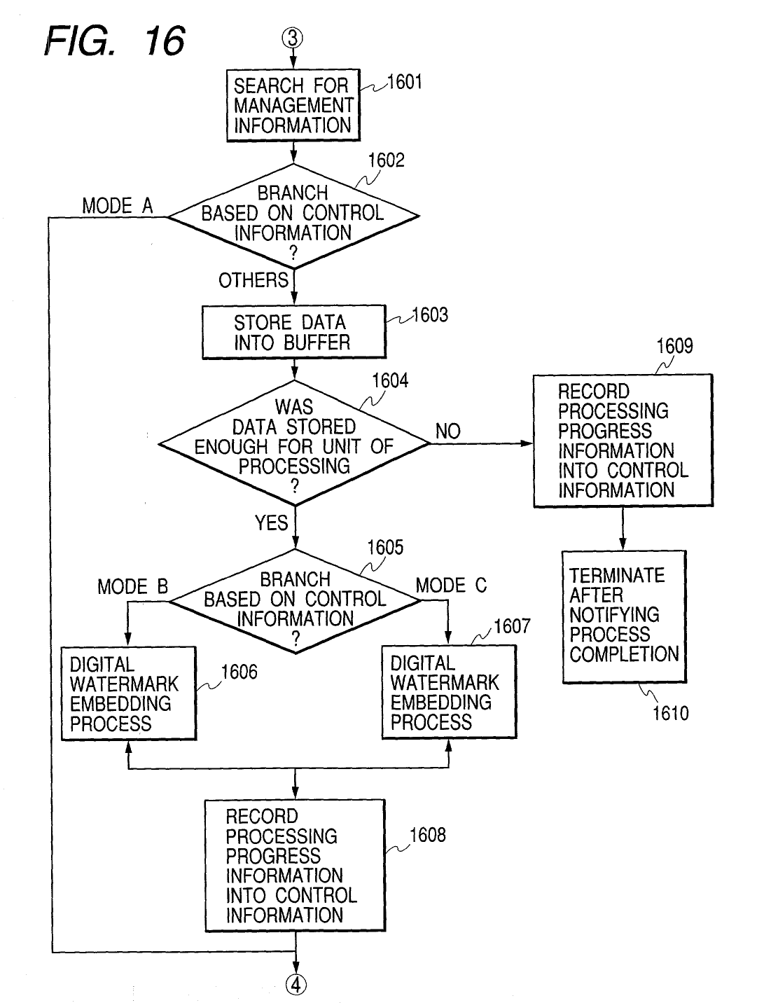

If the flow of the processing goes on to the step 1403, a branch destination of the processing flow is determined in dependence on whether the data to be written has a header A 601 shown in FIG. 12 or a header B 701 shown in FIG. 13. If the data to be written has a header A 601 shown in FIG. 12, the flow of the processing goes on to a step 1407. If the data to be written has a header B 701 shown in FIG. 13, the flow of the processing goes on to a step 1409. If the data to be written is not management-information-setting data, the flow of the processing goes on to a step 1601 of the flowchart shown in FIG. 16.

If the flow of the processing goes on to the step 1407, the local file system 104 makes an access to the file-management information 108 through the storage interface 105 to search the file-management information 108 for fields of the digital-watermark-embedding control information 504, the digital-watermark-embedding parameters 505, the compression/decompression control information 1108 and the compression/decompression parameters 1109 for a file identified by file-identification information given as an argument of the write command. The local file system 104 then updates the fields with the contents of digital-watermark-embedding control information 602, digital-watermark-embedding parameters 603, compression/decompression control information 1204 and compression/decompression parameters 1205, which are included in the management-information-setting data. Finally, at a step 1408, the processing is ended by returning a notice of processing completion to the network-file-sharing protocol 103.

If the flow of the processing goes on to the step 1409, the local file system 104 makes an access to the file-management information 108 through the storage interface 105 to search the file-management information 108 for fields of the digital-watermark-embedding parameters 507 and the compression/decompression parameters 1110. The local file system 104 then updates the fields with the contents of digital-watermark-embedding parameters 702 and the compression/decompression parameters 1303, which are included in the management-information-setting data. In this case, the file-identification information given as an argument of the write command is ignored. Finally, at the step 1408, the processing is ended by returning a notice of processing completion to the network-file-sharing protocol 103.

The following description explains the flow of processing, which is carried out when the flow of the processing goes on to the step 1601 of the flowchart shown in FIG. 16. At the step 1601, the local file system 104 makes an access to the file-management information 108 through the storage interface 105 to search the file-management information 108 for fields of the file size 502, the recording-location information 503, the digital-watermark-embedding control information 504, the digital-watermark-embedding parameters 505, the compression/decompression control information 1108 and the compression/decompression parameters 1109, and obtains the fields from the file-management information 108 for a file identified by file-identification information given as an argument of the write command. In addition, the local file system 104 also obtains the digital-watermark-embedding parameters 507 and the compression/decompression parameters 1110, which are common to all files, from the file-management information 108.

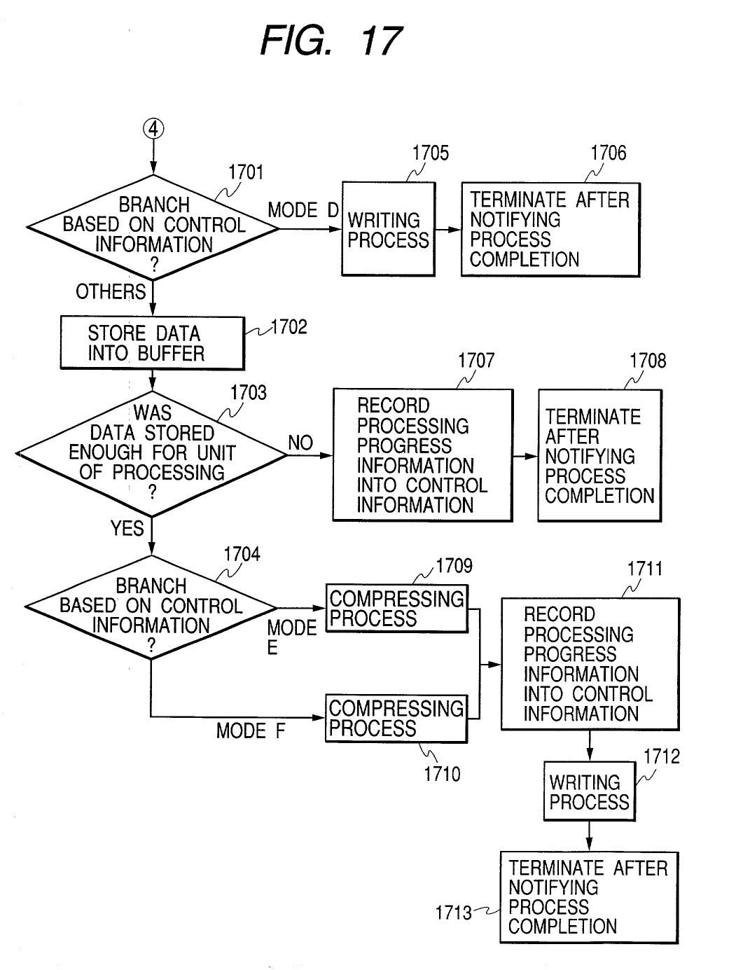

Then, at the next step 1602, a branch destination of the processing flow is determined in accordance with the contents of the digital-watermark-embedding control information 504 obtained at the preceding step. If the digital-watermark-embedding control information 504 shows mode A, that is, a mode in which no digital-watermark-embedding processing is to be carried out, the flow of the processing goes on to a step 1701 of the flowchart shown in FIG. 17, skipping the rest of the processing represented by the flowchart shown in FIG. 16. If the digital-watermark-embedding control information 504 shows mode B, that is, a mode in which digital-watermark-embedding processing is to be carried out by using the digital-watermark-embedding parameters 505 or mode C, that is, a mode in which digital-watermark-embedding processing is to be carried out by using the digital-watermark-embedding parameters 507, on the other hand, the flow of the processing goes on to a step 1603.

If the flow of the processing goes on to the step 1603, the data specified by an argument of the write command as data to be written is stored in the buffer 109. Then, at the next step 1604, a branch destination of the processing flow is determined in accordance with whether or not data of a unit of the digital-watermark processing was stored in the buffer 109. If data of a unit of the digital-watermark processing was not stored in the buffer 109, the flow of the processing goes on to a step 1609. At the step 1609, the local file system 104 makes an access to the file-management information 108 through the storage interface 105 to record processing-progress information for data left in the buffer 109 in the processing-progress information 506 of the file-management information 108 for use in the processing to embed a digital watermark. Finally, at a step 1610, the processing is ended by returning a notice of processing completion to the network-file-sharing protocol 103. If data of a unit of the digital-watermark processing was stored in the buffer 109, on the other hand, the flow of the processing goes on to a step 1605 to again determine a branch destination in accordance with the contents of the digital-watermark-embedding control information 504 obtained at a previous step. If the digital-watermark-embedding control information 504 shows mode B, that is, a mode in which digital-watermark-embedding processing is to be carried out by using the digital-watermark-embedding parameters 505 associated with a specified file, the flow of the processing goes on to a step 1606. If the digital-watermark-embedding control information 504 shows mode C, that is, a mode in which digital-watermark-embedding processing is to be carried out by using the digital-watermark-embedding parameters 507 common to all files, on the other hand, the flow of the processing goes on to a step 1607.

If the flow of the processing goes on to the step 1606, the local file system 104 supplies the digital-watermark-embedding parameters 505 obtained at the step 1601 and the data of one processing unit stored in the buffer 109 to the digital-watermark-embedding processing unit 110, requesting the digital-watermark-embedding processing unit 110 to carry out processing to embed a digital watermark into the data. The digital-watermark-embedding processing unit 110 carries out processing to embed a digital watermark into the data to produce data of one processing unit having an embedded digital watermark. Then, at the next step 1608, processing-progress information is recorded in the processing-progress information 506 for data left in the buffer 109, if any, for use in processing to embed a digital watermark. Then, the flow of the processing goes on to the step 1701 of the flowchart shown in FIG. 17.

If the flow of the processing goes on to the step 1607, on the other hand, the local file system 104 supplies the digital-watermark-embedding parameters 507 obtained at the step 1601 and the data of one processing unit stored in the buffer 109 to the digital-watermark-embedding processing unit 110, requesting the digital-watermark-embedding processing unit 110 to carry out processing to embed a digital watermark into the data. The digital-watermark-embedding processing unit 110 carries out processing to embed a digital watermark into the data to produce data of one processing unit having an embedded digital watermark. Then, at the next step 1608, processing-progress information is recorded in the processing-progress information 506 for data left in the buffer 109, if any, for use in processing to embed a digital watermark. Subsequently, the flow of the processing goes on to the step 1701 of the flowchart shown in FIG. 17.

The following description explains processing carried out at the step 1701 of the flowchart shown in FIG. 17 and the subsequent steps. This processing is a process to compress data following the processing to embed a digital watermark. At the step 1701, a branch destination of the processing flow is determined in dependence on the contents of the compression/decompression control information 1108 obtained at the step 1601 of the flowchart shown in FIG. 16. If the compression/decompression control information 1108 shows mode D, that is, a mode in which processing to compress data is not to be carried out, the flow of the processing goes on to a step 1705. If the compression/decompression control information 1108 shows mode E, that is, a mode in which processing to compress data is to be carried out by using the compression/decompression parameters 1109 or mode F, that is, a mode in which processing to compress data is to be carried out by using the compression/decompression parameters 1110, on the other hand, the flow of the processing goes on to a step 1702.

If the flow of the processing goes on to the step 1705, data is written into a file without carrying out processing to compress data. If the flow of the processing has come from the step 1602, the data written into the file is the data specified by an argument of the write command as data to be written. If the flow of the processing has come from the step 1608, on the other hand, the data written into the file is the data completing the digital-watermark-embedding processing carried out at a previous step. The local file system 104 computes a write location of data to be written in the data recording device 106 and writes the data into the data-recording device 106 through the storage interface 105. The write location is a location at which data to be written is to be recorded. The write location is computed by using the write command's argument indicating a location, at which the data is to be written, as well as a file's file size 502 and recording-information location 503, which have been obtained at the step 1601. Finally, at a step 1706, the processing is ended by returning a notice of processing completion to the network-file-sharing protocol 103.

If the flow of the processing goes on to the step 1702, on the other hand, data is written into a file after processing to compress data. If the flow of the processing has come from the step 1602, the data written into the file is the data specified by an argument of the write command as data to be written. If the flow of the processing has come from the step 1608, on the other hand, the data written into the file is the data completing the digital-watermark-embedding processing carried out at a previous step. In either case, the data to be written is subjected to processing to compress data. That is to say, the data to be written is treated like uncompressed data and stored in the buffer 109. Then, at the next step 1703, a branch destination of the processing flow is determined in accordance with whether or not data of a unit of the compressing was stored in the buffer 109. If data of a unit of the compressing was not stored in the buffer 109, the flow of the processing goes on to a step 1707. At the step 1707, the local file system 104 makes an access to the file-management information 108 through the storage interface 105 to record processing-progress information for data left in the buffer 109 in the processing-progress information 506 of the file-management information 108. Finally, at a step 1708, the processing is ended by returning a notice of processing completion to the network-file-sharing protocol 103. The processing-progress information is the location and the size of data to be written without carrying out processing to compress data. The data to be written is left in the buffer 109. If data of a unit of the compressing was stored in the buffer 109, on the other hand, the flow of the processing goes on to a step 1704 to again determine a branch destination in accordance with the contents of the compression/decompression control information 1108 obtained at a previous step. If the compression/decompression control information 1108 shows mode E, that is, a mode in which processing to compress data is to be carried out by using the compression/decompression parameters 1109 provided for the file, the flow of the processing goes on to a step 1709. If the compression/decompression control information 1108 shows mode F, that is, a mode in which processing to compress data is to be carried out by using the compression/decompression parameters 1110 common to all files, on the other hand, the flow of the processing goes on to a step 1710.

If the flow of the processing goes on to the step 1709, the local file system 104 supplies the compression/decompression parameters 1109 obtained at the step 1601 and the uncompressed data of a processing unit stored in the buffer 109 to the compressing unit 1011, requesting the compressing unit 1011 to carry out processing to compress data. Then, at the next step 1711, if data is left in the buffer 109 in an uncompressed state, the location of the data in the buffer 109 and the size of the data are recorded in the processing-progress information 506. Subsequently, at the next step 1712, the local file system 104 computes a write location of data to be written in the data recording device 106 and writes the data into the data-recording device 106 through the storage interface 105. The data is data returned by the compressing unit 1011 after the data has completed the processing to compress data in the compressing unit 1011. The write location is a location at which data to be written is to be recorded. The write location is computed by using the write command's argument indicating a location, at which the data is to be written, as well as a file's file size 502 and recording-information location 503, which have been obtained at the step 1601. Finally, at a step 1713, the processing is ended by returning a notice of processing completion to the network-file-sharing protocol 103.

If the flow of the processing goes on to the step 1710, on the other hand, the local file system 104 supplies the compression/decompression parameters 1110 obtained at the step 1601 and the uncompressed data of a processing unit stored in the buffer 109 to the compressing unit 1011, requesting the compressing unit 1011 to carry out processing to compress data. Then, at the next step 1711, if data is left in the buffer 109 in an uncompressed state, the location of the data in the buffer 109 and the size of the data are recorded in the processing-progress information 506. Subsequently, at the next step 1712, the local file system 104 stores the data to be written into the data-recording device 106. The data is data returned by the compressing unit 1011 after the data has completed the processing to compress data in the compressing unit 1011. Finally, at the step 1713, the processing is ended by returning a notice of processing completion to the network-file-sharing protocol 103.

The description given so far explains processing carried out for a write command received at the step 1401. The following description explains processing carried out for a read command. Arguments of a read command are file-identification information identifying a file to be read, the size of data to be read out from the file and the data's location from which the data is to be read out.

At the step 1501, the local file system 104 makes an access to the file-management information 108 through the storage interface 105 to search the file-management information 108 for fields of the file size 502, the recording-location information 503, the processing-progress information 506, the compression/decompression control information 1108 and the compression/decompression parameters 1109 and obtains the fields from the file-management information 108 for a file identified by the file-identification information given as an argument of the read command. In addition, the local file system 104 also obtains the compression/decompression parameters 1110 from the file-management information 108.

Subsequently, at the next step 1502, a branch destination of the processing flow is determined in dependence on the contents of the compression/decompression control information 1108 obtained at the step 1501. If the compression/decompression control information 1108 shows mode D, that is, a mode in which processing to compress data is not to be carried out, the flow of the processing goes on to a step 1506 on the assumption that the contents of the file stored in the data-recording device 106 are uncompressed data. If the compression/decompression control information 1108 shows mode E, that is, a mode in which processing to compress data is to be carried out by using the compression/decompression parameters 1109 or mode F, that is, a mode in which processing to compress data is to be carried out by using the compression/decompression parameters 1110, on the other hand, the flow of the processing goes on to a step 1503.

If the flow of the processing goes on to the step 1506, the local file system 104 computes a location from which the data to be fetched is read out from the data recording device by using the size of the data to be read, the location in the file from which the data is to be read, the file size 502 and the recording-location information 503. The size of the data to be read and the location in the file from which the data is to be read are each given as an argument of the read command. Then, the data is read from the data-recording device 106 through the storage interface 105. Finally, at a next step 1507, the processing is ended by returning the read data and a notice of processing completion to the network-file-sharing protocol 103.

On the other hand, the flow of the processing may go on to a step 1503 to consider a case in which data to be read is left in the buffer 109 and still being compressed. To put it in detail, if the processing-progress information 506 obtained at the step 1501 indicates that the data to be read all exists in the buffer 109, the flow of the processing goes on to a step 1508 at which the data to be read is read out from the buffer 109. Then, at the next step 1509, the processing is ended by supplying the data to the network-file-sharing protocol 103 as a processing result. If the data to be read is determined not to exist in the buffer 109 or only a portion of the data to be read is determined to exist in the buffer 109, on the other hand, the flow of the processing goes on to a step 1504 at which the local file system 104 computes a location from which the data to be fetched will be read from the data recording device by using the size of the data to be read, the location in the file from which the data is to be read, the file size 502 and the recording-location information 503. The size of the data to be read and the location in the file from which the data is to be read are each given as an argument of the read command. Then, the data is read from the data-recording device 106 through the storage interface 105.

Subsequently, at the next step 1505, a branch destination of the processing flow is determined in dependence on the contents of the compression/decompression control information 1108 obtained at the step 1501, that is, in dependence on what compression method was adopted. If the compression/decompression control information 1108 shows mode E, that is, a mode in which processing to compress data is to be carried out by using the compression/decompression parameters 1109 associated with a specific file, the flow of the processing goes on to a step 1510. If the compression/decompression control information 1108 shows mode F, that is, a mode in which processing to compress data is to be carried out by using the compression/decompression parameters 1110 common to all files, on the other hand, the flow of the processing goes on to a step 1511.

If the flow of the processing goes on to the step 1510, the local file system 104 supplies the compression/decompression parameters 1109 obtained at the step 1501 and data read from the data-recording device 106 at the step 1504 to the decompressing unit 1012, requesting the decompressing unit 1012 to carry out processing to decompress data. Finally, at a step 1512, the processing is ended by returning data decompressed at the step 1510 and a portion of the data if such a portion is left in the buffer 109 to the network-file-sharing protocol 103 as results of the processing.

If the flow of the processing goes on to the step 1511, on the other hand, the local file system 104 supplies the compression/decompression parameters 1110 obtained at the step 1501 and data read at the step 1504 from the data-recording device 106 to the decompressing unit 1012, requesting the decompressing unit 1012 to carry out processing to decompress data. Finally, at the step 1512, the processing is ended by returning data decompressed at the step 1511 and a portion of the data if such a portion is left in the buffer 109 to the network-file-sharing protocol 103 as results of the processing.

Processing is carried out in the embodiment as described above to allow a client to store video data in the data recording device 106 after processing to embed a digital watermark and/or processing to compress data in a manner similar to the first embodiment. Also in the case of this embodiment, however, it is assumed that video data is written in a sequential fashion so that it is necessary to limit the processing only to clients not desiring random accesses during a write operation.

3. Third Embodiment

A third embodiment's configuration and flow of processing will be described as follows. The third embodiment is obtained by making changes to the first embodiment. To put it in detail, the third embodiment is a monitoring system applied to a network monitoring camera system for recording image inputs received from a plurality of monitoring cameras into a common storage device 100 through a network. In the network monitoring camera system, the monitoring cameras are connected to the storage device 100 through the network. An image generated by any of the monitoring cameras can be recorded in the storage device 100 through a network-file-sharing protocol. At that time, information such as the identifying number of the monitoring camera and the photographing date/time is embedded in the digital data of the image as a digital watermark in processing to embed the digital watermark. In this way, proof information can be brought about to the image. It should be noted that only differences from the first embodiment are explained.

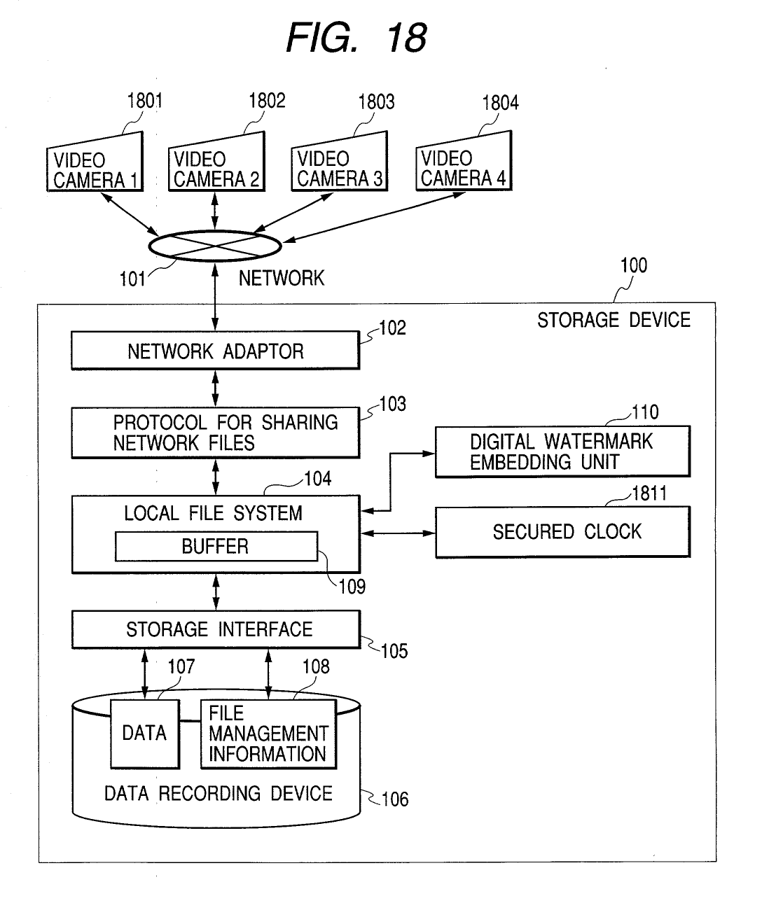

First of all, the configuration of a network monitoring camera system and a storage device implemented by the third embodiment are explained by referring to FIG. 18. In addition to components employed in the first embodiment, the network monitoring camera system also includes a plurality of monitoring video cameras 1801 to 1804 connected to the storage device 100 through the network 101.

In addition, the local file system 104 is connected to a secured-clock unit 1811. The secured-clock unit 1811 generates a clock signal with time information that cannot be falsified. Controlled by the local file system 104, the secured-clock unit 1811 returns information on the present date and the present time to the local file system 104 in response to a request made by the local file system 104.

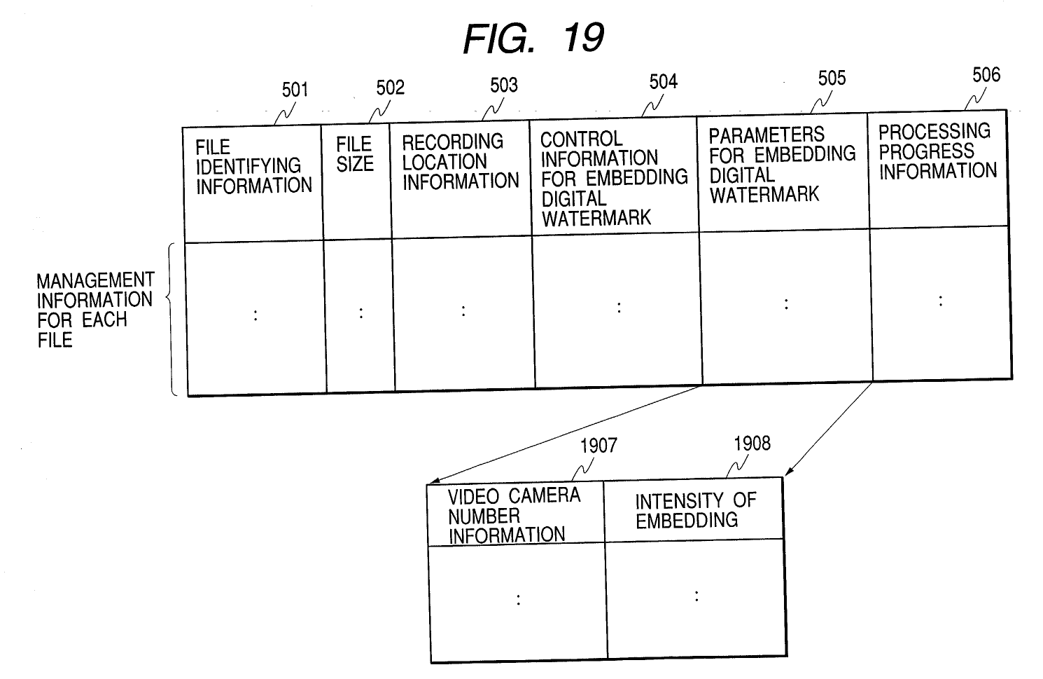

The file-management information 108 used in this embodiment is a table similar to that used in the first embodiment. As shown in FIG. 19, however, the file-management information 108 used in this embodiment includes video camera number information 1907 as part of the digital-watermark-embedding parameters 505. In addition, the digital-watermark-embedding control information 504 shows mode G or H. Mode G is a mode in which no processing to embed a digital watermark is to be carried out prior to an operation to write data into a file. On the other hand, mode H is a mode in which processing to embed a digital watermark is to be carried out. If no information is set in the digital-watermark-embedding control information 504, mode G is assumed to be the default mode.

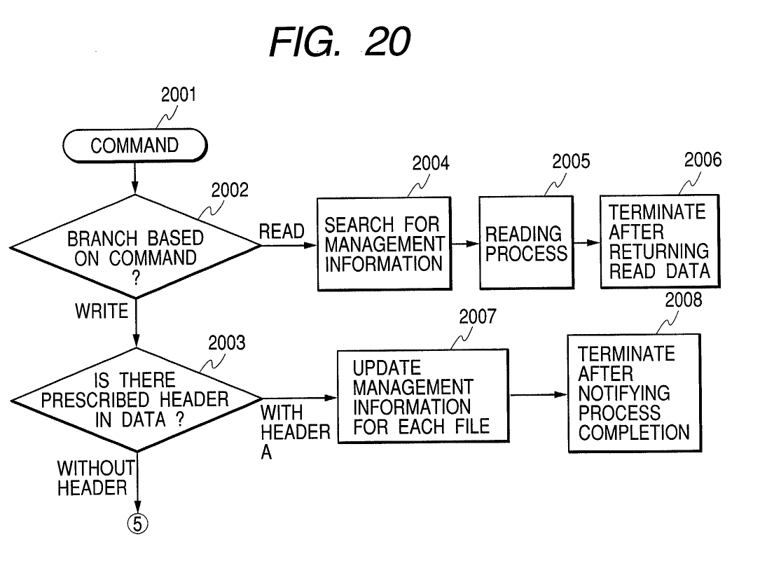

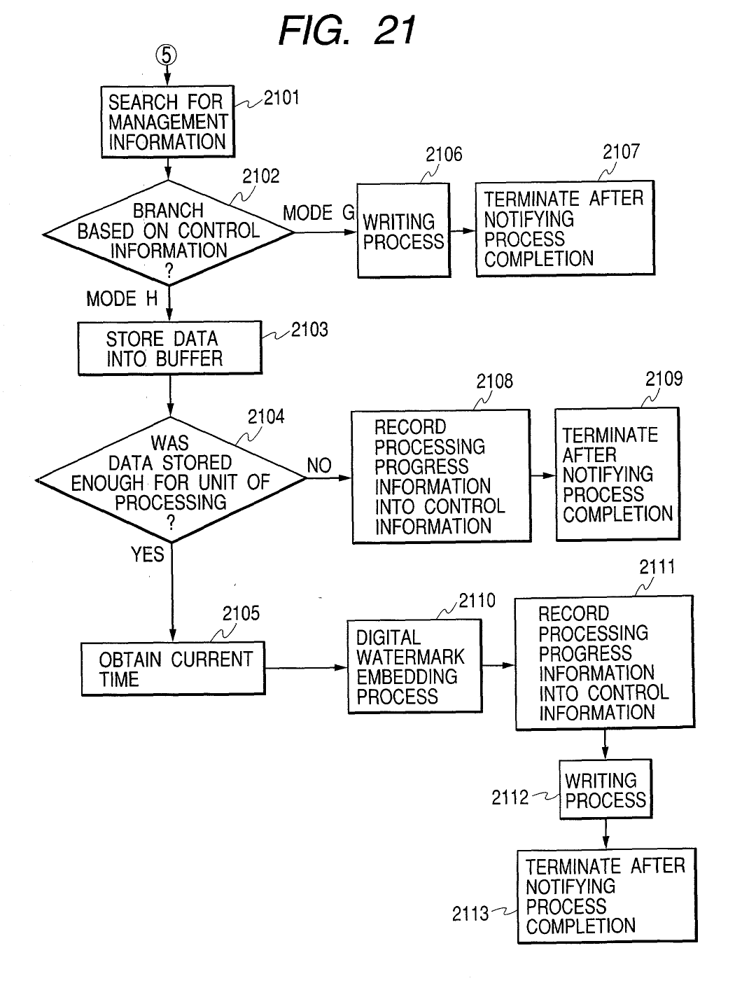

By referring to FIG. 18 and flowcharts shown in FIGS. 20 and 21, the following description explains details of a flow of processing carried out in the third embodiment as requested by a command issued by a client. Since processing carried out for a read command is the same as the processing in the first embodiment, only the flow of processing carried out for a write command is explained.

If a command 2001 is a write command, the flow of the processing goes on to a step 2003. Arguments of a write command include file-identification information identifying a file into which data is to be written, data to be recorded into the file and a location at which data is to be recorded in the file.

If the flow of the processing goes on to the step 2003, a branch destination of the processing flow is determined in dependence on whether or not the data specified by an argument of the write command as data to be written is management-information-setting data with a header A 601 shown in FIG. 6. If the data to be written is management-information-setting data with a header A 601 shown in FIG. 6, the flow of the processing goes on to a step 2007. If data to be written is not management-information-setting data, on the other hand, the flow of the processing goes on to a step 2101 of the flowchart shown in FIG. 21.

If the flow of the processing goes on to the step 2007, the local file system 104 makes an access to the file-management information 108 through the storage interface 105 to search the file-management information 108 for fields of the digital-watermark-embedding control information 504 and the digital-watermark-embedding parameters 505, which are associated with a file indicated by the file-identification information given as an argument of the write command, and to update the fields with contents of fields of the management-information-setting data's digital-watermark-embedding information 602 and digital-watermark-embedding parameters 603. Finally, at a step 2008, the processing is ended by returning a notice of processing completion to the network-file-sharing protocol 103.

By referring to the flowchart shown in FIG. 21, the following description explains the flow of processing, which is carried out in case a branch to the step 2101 is made. At the step 2101, the local file system 104 makes an access to the file-management information 108 through the storage interface 105 to search the file-management information 108 for fields of the file size 502, the recording-location information 503, the digital-watermark-embedding control information 504 and the digital-watermark-embedding parameters 505, which are associated with a file indicated by the file-identification information given as an argument of the write command, and obtains the fields from the file-management information 108. Then, at the next step 2102, a branch destination of the processing flow is determined in dependence on the contents of the digital-watermark-embedding control information 504 obtained at the preceding step. If the digital-watermark-embedding control information 504 shows mode G, that is, a mode in which no processing to embed a digital watermark is to be carried out, the flow of the processing goes on a step 2106. If the digital-watermark-embedding control information 504 shows mode H, that is, a mode in which processing to embed a digital watermark is to be carried out, on the other hand, the flow of the processing goes on to a step 2103.

If the flow of the processing goes on to the step 2106, the local file system 104 computes a write location of data to be written in the data recording device 106 and writes the data into the data-recording device 106 through the storage interface 105. The write location is computed by using the write command's argument indicating a location, at which the data is to be written, as well as a file's file size 502 and recording-information location 503, which have been obtained at the step 2101. Finally, at a step 2107, the processing is ended by returning a notice of processing completion to the network-file-sharing protocol 103.

If the flow of the processing goes on to the step 2103, on the other hand, data specified by an argument of the write command is stored in the buffer 109. Then, at the next step 2104, a branch destination of the processing flow is determined in accordance with whether or not data of a unit of the digital-watermark-embedding processing has been stored in the buffer 109. If data of a unit of the digital-watermark-embedding processing was not stored, the flow of the processing goes on to a step 2108. At the step 2108, the local file system 104 makes an access to the file-management information 108 through the storage interface 105 and records processing-progress information for data left in the buffer 109 into the processing-progress information 506 of the file-management information 108 for use in processing to embed a digital watermark. Finally, at a step 2109, the processing is ended by returning a notice of processing completion to the network-file-sharing protocol 103.

If data of a unit of the digital-watermark-embedding processing was stored, on the other hand, the flow of the processing goes on to a step 2105 at which the local file system 104 obtains information on a present date/time from the secured-clock unit 1811. At the next step 2110, the local file system 104 supplies the digital-watermark-embedding parameters 505 obtained at the step 901, data of one processing unit stored in the buffer 109 and the information on a present date/time to the digital-watermark-embedding processing unit 110, requesting the digital-watermark-embedding processing unit 110 to carry out processing to embed a digital watermark. The information is supplied to the digital-watermark-embedding processing unit 110 to be used also as a parameter.

The digital-watermark-embedding processing unit 110 carries out the processing to embed a digital watermark by using the video camera number information 1907 included in the digital-watermark-embedding parameters 505 and the information on a present date/time into the video data as embedded information. Then, at the next step 2111, if data is left in the buffer 109, processing-progress status is recorded in the processing-progress information 506 for use in the processing to embed a digital watermark. Subsequently, at the next step 2112, the local file system 104 computes a write location of data to be written in the data recording device 106 and writes the data into the data-recording device 106 through the storage interface 105. The data is data returned by the digital-watermark-embedding processing unit 110 after the data has completed the processing to embed a digital watermark in the digital-watermark-embedding processing unit 110. The write location is a location at which data to be written is to be recorded. The write location is computed by using the write command's argument indicating a location, at which the data is to be written, as well as a file's file size 502 and recording-information location 503, which have been obtained at the step 2001. Finally, at a step 2113, the processing is ended by returning a notice of processing completion to the network-file-sharing protocol 103.

The processing described above is carried out in the storage device implemented by this embodiment. In addition, in the monitoring camera system, a monitoring camera serving as a client carries out processing as follows in order for the system to work correctly.

Any of the monitoring video cameras 1801 to 1804 connected to the network 101 sets typically mode H in the digital-watermark-embedding control information 504 as management-information-setting data when the power supply is turned on in order to create management-inform-setting data setting a peculiar camera number in the video camera number information 1907 of the digital-watermark-embedding parameters 505. As described earlier, mode H is a mode in which processing to embed a digital watermark is to be carried out. In order to write an image produced by a monitoring video camera as a file, after the file is generated through the network-file-sharing protocol 103, first of all, the management-information-sharing data is written through the network-file-sharing protocol 103. In this way, processing to embed a digital watermark into the file becomes valid, allowing video camera number information and information on a date/time to be embedded into the video data generated by the monitoring video camera as embedded information prior to an operation to record the video data into the data-recording device 106.

It should be noted that, while data is not compressed in the case of the third embodiment, the data may be compressed in the same way as the second embodiment.

In accordance with the present invention, by adding a means for embedding a digital watermark into data and/or a means for compressing data to the sharable storage device, it is not necessary for each individual client to have a means for embedding a digital watermark into data and/or a means for compressing data. In addition, by extending a file-management information area of the conventional file system, it is possible to intensively manage control parameters required in processing to embed a digital watermark into data and processing to compress data with ease.

What is claimed is:

1. A storage device provided with a file system for managing operations to write and read data file by file in concentrated accesses made by a plurality of client apparatuses to said storage device through a network, said storage device comprising:
a first storage means for storing a digital-watermark-embedding parameter for each file as part of file-management information;
a second storage means for storing file data;
a receiving means for receiving a request to write file data from any of said client apparatuses;
a processing means for embedding a digital watermark into each processing unit of file data to be written as requested by any of said client apparatuses; and
a file-system means for driving said processing means on the basis of said digital-watermark-embedding parameter provided in said file-management information for a specific file and storing said specific file's data including an embedded digital watermark into said second storage means.

2. A storage device according to claim 1, said storage device further comprising:
a buffer for storing data less than said processing unit; and
a means for recording information on data stored in said buffer as part of said file-management information.

3. A storage device according to claim 1, said storage device further comprising a third storage means for storing a digital-watermark-embedding parameter common to all files, wherein said file-system means drives said processing means on the basis of said digital-watermark-embedding parameter common to all files instead of said digital-watermark-embedding parameter provided in said file-management information for a specific file.

4. A storage device according to claim 1, wherein said file data includes video data.

5. A storage device provided with a file system for managing operations to write and read data file by file in concentrated accesses made by a plurality of client apparatuses to said storage device through a network, said storage device comprising:
a first storage means for storing a digital-watermark-embedding parameter and a compression parameter, which are provided for each file as part of file-management information;
a second storage means for storing file data;
a receiving means for receiving a request to write file data from any of said client apparatuses;
a first processing means for embedding a digital watermark into each first processing unit of file data to be written as requested by any of said client apparatuses;
a second processing means for compressing each second processing unit of said file data to be written as requested by any of said client apparatuses; and
a file-system means;
wherein said file-system means includes a means for driving said first processing means on the basis of said digital-watermark-embedding parameter provided in said file-management information for a specific file, a means for driving said second processing means on the basis of said compression parameter provided in said file-management information for said specific file, and a means for storing said specific file's data including an embedded digital watermark into said second storage means after compressing said specific file's data including said embedded digital watermark.

6. A storage device according to claim 5, said storage device further comprising:
a buffer for storing data less than said first processing unit and less than said second processing unit; and
a means for recording information on data stored in said buffer as part of said file-management information.

7. A storage device according to claim 5, said storage device further comprising a third storage means for storing a digital-watermark-embedding parameter and a compression parameter, which are common to all files, wherein said file-system means drives said first processing means and said second processing means on the basis of respectively the digital-watermark-embedding parameter and the compression parameter, which are common to all files, instead of said digital-watermark-embedding parameter and said compression parameter, which are provided in said file-management information for a specific file.

8. A storage device according to claim 5, wherein said file data includes video data.

9. A monitoring system including a storage device provided with a file system for managing operations to write and read data file by file in concentrated accesses made by a plurality of monitoring cameras to said storage device through a network, said storage device comprising:
a first storage means for storing a digital-watermark-embedding parameter for each file as part of file-management information;
a second storage means for storing video data as file data;
a receiving means for receiving a request to write file data from any of said monitoring cameras;
a processing means for embedding a digital watermark into each processing unit of file data to be written as requested by any of said monitoring cameras; and
a file-system means for driving said processing means on the basis of said digital-watermark-embedding parameter provided in said file-management information for a specific file and storing said specific file's data including an embedded digital watermark into said second storage means.

10. A monitoring system according to claim 9 wherein said digital-watermark parameter includes camera-number information and said processing means embeds said camera-number information and information on a date/time into said video data.
